(19) United States
(12) Patent Application Publication
(10) Pub. No.: US 2006/0266671 A1
(43) Pub. Date: Nov. 30, 2006

(54) Mold and method for forming packages and packages manufactured therewith

(75) Inventor: Alfred Langerak, Mijnsheerenland (NL)

Correspondence Address: HOFFMANN & BARON, LLP, 6900 JERICHO TURNPIKE, SYOSSET, NY, 11791, US

(73) Assignee: FOUNTAIN TECHNOLOGIES B.V., Capelle aan den Ijssel (NL)

(21) Appl. No.: 10/553,334

(22) PCT Filed: Apr. 15, 2004
(86) PCT No.: PCT/NL04/00258

§ 371 Date: Jul. 12, 2006

(30) Foreign Application Priority Data
Apr. 15, 2003 (NL) 1023185

(51) Int. Cl. B65D 5/52; B29C 45/00; A23P 1/00

(52) U.S. Cl. 206/736; 425/577

(57) ABSTRACT

A mold for manufacturing a package for products, comprising at least one mold cavity for forming the package, wherein in the mold cavity hinge forming means are provided for forming hinge means, while on a first side of the hinge forming means at least a first insert piece is provided for forming suspension means for the package and, on the opposite side, at least a second insert piece is provided for forming a receiving cavity in the package, the first and second insert piece being exchangeable for different first and or/second insert pieces with a configuration deviating from the first and second insert pieces, respectively.

The invention relates to a mold for forming a package. In particular, the invention relates to a mold for a package for products such as consumer packages, suitable for display in a shop or a similar sales space, or sale via sales channels such as mail order companies and the like.

As a rule, relatively small products such as consumer articles, for instance memory chips, memory sticks, batteries, cards and the like are packaged in blister packages. As a rule, blister packages are packages with a small wall thickness, manufactured from plastic, which can enclose a product between two parts hinging relative to each other. The outer dimensions of such a package are large such that, in order to prevent theft, the package is prevented from being too easily slid into a trouser pocket or the like. In different embodiments, such a package is provided with, for instance, a cardboard insert sheet for product information.

Further, blister packages are often formed by thin, cover-shaped parts from plastic, formed through vacuum formation, which are arranged on or around an end sheet, for instance with glue, staples or through form-closing. Such packages have as a drawback that they are not manufactured from one material and therefore lead to waste problems, in particular with consumers.

It has already been proposed to manufacture packages of a blister package type by injection molding, wherein two closing parts are connected by integrally formed hinge means. In at least one closing part, a suspension means such as an opening or hooking element is then provided, in at least the other closing part a cavity for forming a receiving cavity. In the receiving cavity a product can be enclosed.

This known injection molded package has the drawback that for each type of product to be packaged, a different package is to be formed and that therefore, for each product, a separate mold is to be purchased. Even when one product is to be packaged for different markets or during special actions, an adjusted mold is to be purchased. The fact is that, if a different product or assembly of products will be packaged in the same package, for instance the receiving cavity will be too small or too large and/or not be optimal as to shape for the respective product or assembly of products, while moreover, the suspension means will then be incorrectly placed, so that suspension will lead to an undesired skew position of the package.

The object of the invention is a mold for forming a package for products, of the type described hereinabove. To that end, a mold according to the invention is characterized by the features of claim 1.

With a mold according to the invention, different packages can be formed, mutually differing as to, for instance, position and/or configuration of the suspension means and/or the position and/or the configuration of the receiving cavity. Moreover, by exchanging the inserts pieces, the closing parts can be adjusted. Thus, by simply exchanging one or more insert pieces, with the same mold, each time, a suitable package can be injection molded. With it, adjustment of the package is possible in a particularly rapid and simple and economic manner.

Preferably, a mold according to the invention is further characterized by the features of claim 4 and/or 5.

By placing opposite the or each first and/or second insert piece a third or fourth insert piece, respectively, an even greater freedom is obtained for adjusting the location and/or configuration of suspension means, receiving cavity and/or closing parts.

In a particularly advantageous embodiment, the mold according to invention is further characterized by the features of claim of 6.

In such an embodiment, slightly curved closing parts are obtained such that a package that can be formed with the mold can stand in closed condition on, for instance, a counter, table or similar surface. With this, an additional display possibility is obtained. In particular with such an embodiment, a first insert piece can be omitted or be designed so as to be closed.

Preferably, with such an embodiment, the curved longitudinal edge is at least substantially formed by the hinge forming means. Then, the package can be displayed on the hinging means.

Preferably, a mold according to the invention is designed such that at least the first and second insert piece are placed or can be placed such that the suspension means and receiving cavities to be formed therewith are on a straight line which approximately includes a right angle with a hinge line defined by the hinge means. In this manner, each time, a package can be obtained depending on, for instance, the weight, the shape and the like of a product to be packaged, which package with product included therein can be suspended in a predetermined, desired position, for instance with the hinge line, defined by the hinge means, horizontally. Naturally, alternatively, also the location of the receiving cavity relative to the suspension means can be adjusted such that a line drawn through these, at least a line through the suspension means to be formed and a centre of gravity of the product, includes a predetermined angle, deviating from 90°, with a hinge line defined by the hinge means such that said hinge line, particularly when the package is suspended, includes a desired angle with the horizontal. By using a mold according to the invention, for similar packages for different products, the respective angle can be set to be the same each time, by placing a different first insert piece, at least second insert piece, depending on the product to be packaged and the receiving cavity used thereto.

The invention further relates to a method for forming a package, characterized by the features of claim 9.

With a suitable choice of a first and second insert piece, each time, a desired suspension position for a package with product to be packaged therein can be determined, depending on, for instance, form, weight and weight distribution of the respective product, the form of the package and the like. In. this manner, a series of similar packages can be obtained for similar products while the products can differ for instance as to form and/or composition, while a package can be adjusted, for instance, for a sales action.

The invention further relates to a package, characterized by the features of claim 11.

Such a package has the advantage that it can be manufactured from one material, while the package can stand independently, in closed condition, which is advantageous from a commercial and/or logistic point of view. Furthermore, the curved form has the advantage that the packages can be suspended more easily in a desired predetermined position and, in particular if the suspension means are formed by an opening, can be arranged better on, for instance, a suspension pin or such display unit.

The invention further relates to a package according to claim 12.

Such a package offers the advantage that products packaged therein are relatively well protected, also from theft and can be displayed in a simple manner, for instance by suspension from suspension means or by display on or in a sales surrounding. After having purchased the package, a user can open it, break the sub-package from the closing parts and then carry along or store the product in this sub-package. Thus, a multifunctional package is obtained. Preferably, the sub-package has its own closing means and hinge means while the hinge means are preferably placed in the package such that when the package is closed, also the two cover parts of the sub-package are moved against each other, more in particular while enclosing the product therein.

The invention further relates to a series of packages, characterized by the features of claim 14.

In the subclaims, further advantageous embodiments of a mold, method and package according to the invention are given. In clarification of the invention, exemplary embodiments of a mold, method and package according to the invention will be further elucidated, with reference to the drawing. In the drawing:

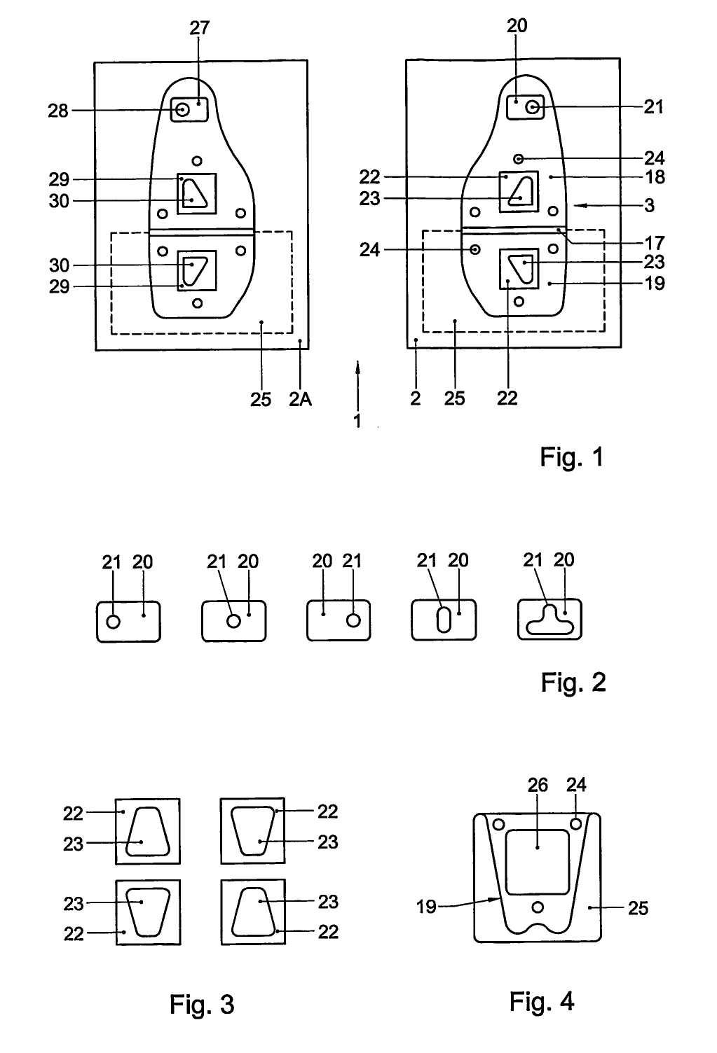

FIG. 1 shows, in top plan view, a mold according to the invention, in opened condition;

FIG. 2 shows a series of first insert pieces;

FIG. 3 shows a pair of second insert pieces;

FIG. 4 shows an alternative embodiment of a second insert piece;

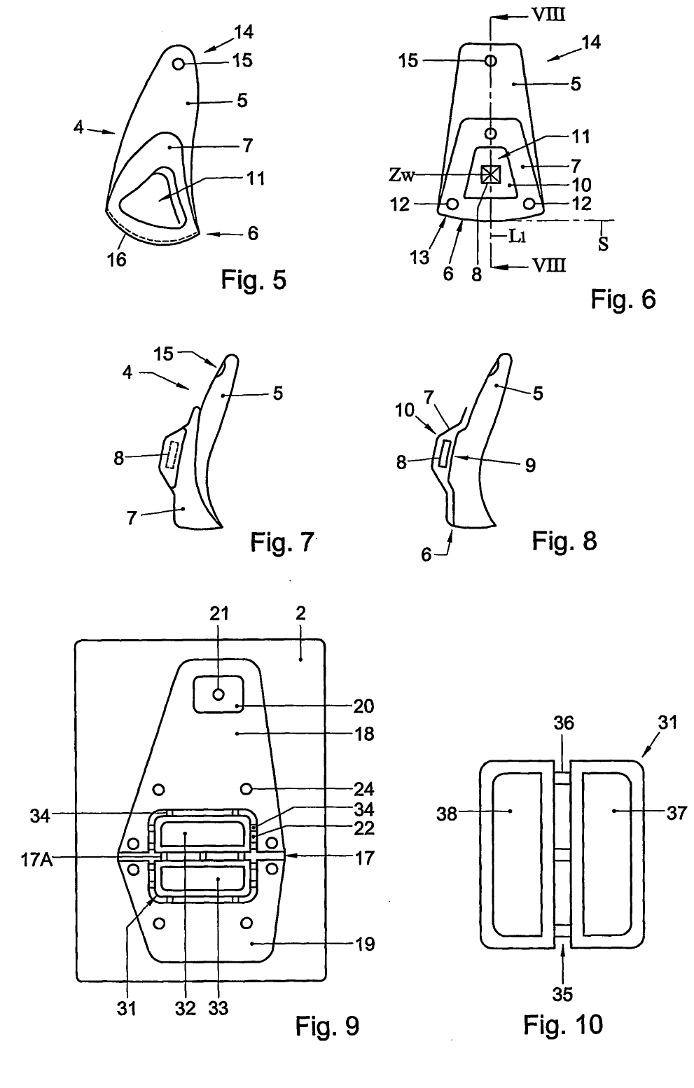

FIG. 5 shows a package according to the invention, in perspective view;

FIG. 6 shows a package comparable to the one shown in FIG. 5, in front view;

FIG. 7 shows a package comparable to the one shown in FIGS. 5 and 6, in side view;

FIG. 8 shows a package according to FIG. 7, in cross-sectional side view;

FIG. 9 shows a mold according to the invention, in an alternative embodiment;

FIG. 10 shows a sub-package, in opened condition, and

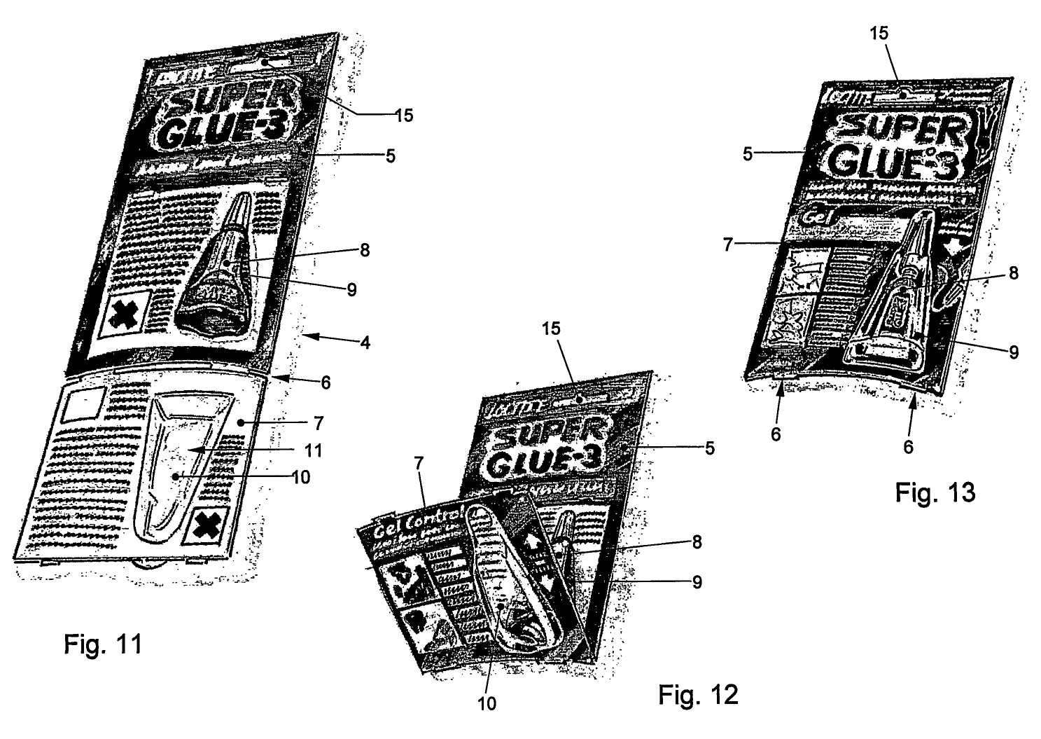

FIGS. 11-13 show a package according to the invention, in three positions.

In this description and the Figures, identical or corresponding parts have identical or corresponding reference numerals. In the exemplary embodiments shown, only a limited number of exemplary embodiments are shown by the way of illustration. It will be clear that, naturally, many different representations of packages according to the invention are possible, with associated molds. The outer contours of, for instance, closing parts, receiving cavities, the layout of, for instance, printing and the like can, naturally, be substantially freely chosen within the invention. In the exemplary embodiments shown, each time, an injection molding mold or injection molded product is shown, which is preferred within the invention. However, a package according to the invention could also be formed by vacuum formation, while a mold according to a FIG. 1 or 9 could be used, designed as a vacuum forming mold. However, injection molding is preferred as, with it, a larger design choice and choice of material are possible and, furthermore, higher production speeds can be achieved, better product finishing can be obtained and, for instance, in mold labelling is possible in a simple manner.

Preferably, a package according to the invention is manufactured from substantially transparent plastic, for instance polyethylene, poly propylene, polystyrene, ABS, P. E. T. or the like, which plastics should not be construed to be limitative in any manner. Also non-transparent, opaque materials can be used or a combination of materials can be used, for instance also by 2K injection molding techniques. However, in the description, each time, a single injection molding mold for 1K injection molding will be the starting point.

In FIG. 1, a mold 1 according to the invention is shown, at least a first and second closing part 2, 3 thereof. In simplification, runners, heating and cooling means, ejector means and the like have been omitted. They can be provided in the customary manner.

In FIG. 1, on the right-hand side, a first mold part 2 is shown, comprising a mold cavity 3 for forming a package 4 according to the invention, as shown, for instance, in FIGS. 5-8 or 11-13. For a better understanding of the mold 1, first, a package 4 will be described more generally.

FIG. 5 shows a package 4 comprising a first closing part 5 and, connected thereto via hinge means 6, a second closing part 7. The hinge means 6 are, for instance, integrally injection molded living hinges and can comprise one continuous film hinge, but in a preferred embodiment they can also be relatively narrow strips, so that also when the closing parts 5, 7 are curved, the hinge means 6 can be functional.

In FIGS. 7 and 8, in side view and cross-sectional side view, respectively, a package 4 according to the invention is shown with a product 8 confined therein, for instance an electronic component. The product 8 is relatively small of dimension and relatively expensive, the package 4 in contrast is relatively large so that it cannot simply be slid into, for instance, a trouser pocket.

As clearly appears, the first closing part 5 and the second closing part 7 each comprise a deformation 9, 10 such that therebetween, a receiving cavity 11 is enclosed if the closing parts 5, 7 are moved against each other, as shown in FIGS. 5-8 or 11-13. The closing parts 5 and 7 are provided with cooperating closing means 12, 13, for instance projections and recesses, respectively, which fit into each other in a form-closing, clamping manner, as is known from blister packages. However, the closing means can also be of different design, for instance glue means, welding means, staples, other types of form-closing fasteners or clamping fasteners and the like. For the present invention, it is only important that the closing parts 5, 7 can be attached in the closed position while confining the product 8.

In the exemplary embodiments shown, in the first closing part 5, adjacent an upper end 14 thereof, a suspension means 15 is provided in the form of an opening. However, the suspension means 15 can also be designed in a different manner, for instance in the form of a hook, loop or the like.

The deformations 9 and 10 are adjusted to, inter alia, the product 8 to be packaged, both in form and in dimension and, optionally, in position relative to the respective closing part 5, 7. As shown in FIG. 6, in this embodiment, the suspension means 15 is located on a line L₁ on which, also, the center of gravity Zw of the product 8 is located and which line L₁ includes an angle α with a hinge line S which is defined by the hinge means 6. In the embodiment shown, the angle α is approximately 90°. It will be clear that if a different product 8 is to be packaged in a package 4 according to the invention, at least the receiving cavity 11 and, hence, the deformations 9 and/or 10 are to be adjusted, while the center of gravity Zw will move relative to the position shown in FIG. 6, and therefore away from line L₁ as drawn. This means that if the package with such a deviating product will be suspended by the suspension means 5, the hinge line S will no longer extend horizontally, which is undesired. By using the mold according to the invention, this can be solved in a simple manner, through exchange of insert pieces as will be described hereinafter. Therewith, a series of packages 4 according to the invention can be manufactured in one and the same mold, which can comprise different products or combinations of products and still, each time, can be suspended in approximately the same position by the suspension means and/or can be displayed on a display surface.

As clearly appears from FIGS. 5-8 and 11-13, the closing parts 5 and 7 as well as the hinge means 6 are curved such that the package 4 can be displayed on the longitudinal edge 16 formed by the hinge means 6 and/or the edges of the closing parts 5, 7 adjacent the hinge means 6. Therefore, the package can be freestanding, presenting an attractive appearance. Moreover, thus, the form fidelity of the package is considerably increased and the package can be suspended by the suspension means 5 in a simpler and tidier manner. In the exemplary embodiments shown, each time, both in the first closing part 5 and the second closing part 7, a deformation 9 or 10, respectively, have been provided. However, it will be clear that such a deformation 9, 10 can also be provided only in one closing part 5, 7 or that these deformations can be provided in opposite directions. Also, in the first and/or second closing part 5, 7, several deformations can be provided, for instance for enclosing different products, associating parts and the like.

As indicated, in the FIGS. 1 and 9, schematically, molds 1 according to the invention are shown, with which a package 4 according to the invention can be formed. To that end, the cavity 3 comprises hinge forming means 17 for forming, in a customary manner, living hinges, hinge strips or the like, a first molded part 18 on a first side of the hinge forming means 17 and a second molded part 19 on the opposite, second side thereof. The first molded part 18 comprises a first insert piece 20 with a first form element 21 for forming a suspension element 15. In FIG. 2, a series of first insert pieces 20 is shown, each of which is exchangeable for the first insert piece 20 received in the first mold part 2. The first insert pieces 20 as shown are distinguished from each other by the position and/or form and/or configuration of the first form element 21. The second molded part 19 comprises a second insert piece 22, exchangeable for another second insert piece 22 as shown in FIG. 3. These second insert pieces 22 each comprise a second form element 23 for forming a deformation 10 in the second closing part 7. In the embodiment shown, in the first molded part 18 a second insert piece 22 is provided for forming the deformation 9 in the first closing part 5. This second insert piece 22 too is exchangeable for a comparable second insert piece 22 as shown in FIG. 3. The insert pieces 22 are distinguished from each other through form, position and/or configuration of the second form element 23.

As is clear from FIG. 1, the molded parts 18, 19 are designed for forming the first and second closing part 5, 7, respectively. Third form elements 24 are provided for forming closing means 12 and 13, respectively. Optionally, these can also be provided on insert pieces, so that their position too can be adjusted, depending on, for instance, the first and/or the second insert pieces, the product to be packaged, user preferences and the like.

In FIG. 1, in interrupted lines, an alternative insert piece 25 is drawn, of which, in FIG. 4, schematically, an example is shown. Through exchange with such an insert piece, 25, for instance, the form, dimension and/or configuration of the second closing part 7 can be adjusted, the second molded part 19 of which has been drawn in FIG. 4. In this insert piece 25, in the embodiment shown, a recess 26 is provided in which a second insert piece 22 can be placed, depending on the desired deformation by a deforming part 23. Thus, with the same mold 1, an even larger design choice is obtained.

It will be clear that a mold 1 according to FIG. 1 offers a great flexibility for adjustment of the mold for forming different packages as shown in FIGS. 5-8 or 11-13, while, for instance, the position of the first form element 21 can be adjusted to a second insert piece 22 used, such that a desired pre-selected position of the line L₁ is obtained, with a closed package formed with this mold. It will be clear that the first molded part 18 too, for that matter, can be provided on a comparable insert piece, so that this can be exchanged too. Moreover, such an insert piece 25 can also be designed without opening 26, while a second form element 23 can be directly provided on the respective insert piece 25.

In FIG. 1, on the left hand side, schematically, a second mold part 3 is shown, which is complementary to the first mold part 2. A third insert piece 27 is provided therein, complementary to the first insert piece 20 and comprising a complementary first form element 28. This third insert piece 27 can be exchanged together with the first insert piece 20. In a comparable manner, two fourth insert pieces 29 are provided with form elements 30, complementary to and exchangeable for the third insert pieces 22 and form elements 23 provided thereon.

In FIG. 9, schematically, an alternative embodiment is shown of a first mold part 2 according to the invention, again provided with a first molded part 18 on a first side of the hinge forming means 17 and a second molded part 19 on the opposite side. First and second molded part 18, 19 are designed for forming a first and second closing part 5, 7, respectively, comparable to those shown in FIGS. 5-8. The first molded part 18 comprises, again, a first insert piece 20 with first form element 21, exchangeable, again, for other first insert pieces 20, as shown in FIG. 2. In this embodiment, a second insert piece 22 is provided which is partly located in the first molded part 18 and partly in the second molded part 19. Therefore, this second insert piece 22 encloses a part 17A of the hinge forming means 17. In the second insert piece 22, a forming part 31 is provided for forming a sub-package 31 as schematically shown in FIG. 10. In the first molded part 18, this forming part 31 comprises a part 32 forming the first cover part and, on the opposite side of the hinge forming part 17A, a second cover part forming part 33. Around the first cover part forming part 32 and the second cover part forming part 33, break lip forming parts 34 are provided for connection with the first closing part 5 and second closing part 7, respectively. Relatively thin, easily breakable break lips can be formed therein.

In FIG. 10, a sub-package 31 according to the invention is shown, in opened condition, comprising hinge elements 35 in the form of lips 36, a first cover part 37 formed in the first cover part forming part 32 and a second cover part 38 formed in the second cover part forming part 33. This sub-package 31 is broken from the closing parts 5, 7 after a package 4 formed in a mold 1 according to FIG. 9 is opened. It is preferred that the break lips 34 are designed such that the sub-package 31 can only be taken from the package 4 by cutting, cutting with scissors or the like, so that with the package still closed, it cannot simply be pressed from of the package. A product 8 (not shown in FIG. 10) can be received in the package 4 in the sub-package 31, between the two cover parts 37, 38 such that, also when the package 4 is closed, the product 8 is confined in the sub-package 31. Naturally, a sub-package 31 as shown in FIG. 10 can also be freely received in a receiving cavity 11 in the package as shown in FIGS. 5-8 or 11-13.

At least to one, and preferably to both closing parts 5, 7, preferably with the aid of printing technique or in mold labelling, a print is applied, for instance product information, instructions for use or the like. With this, loose cards or the like need not be used and a mono package worthy of a “green dot” is obtained. Furthermore, with this, each time, the authenticity of the package with the product packaged therein can be guaranteed. However, naturally, loose or glued-in cards, sheets and the like can be used too.

FIG. 11 shows a package 4 according to the invention, in opened position, for glue. In this embodiment, both the first closing part 5 and the second closing part 7 comprise a deformation 9, 10, in opposite directions. As a result, a receiving cavity 11 is obtained for receiving the product 8, here, a tube of glue. In FIG. 12, the same package is shown during closing. It is clear that then, the part forming the deformation 9 and/or 10 is transparent, while the further package has been printed on, in particular by in mold labelling. In FIG. 13, the same package 4 is shown in closed condition, while the second part 7 is attached against the first part 5 so that the product is confined while being visible.

The invention is not limited in any manner to be exemplary embodiments represented in the description and the drawing. Many variations thereon are possible within the framework of the invention as outlined by the claims.

For instance, several insert pieces can be used in the same mold, different materials can be used, the closing parts 5, 7 can have different forms, dimensions and the like, the closing parts 5, 7, at least the hinge means can be designed to be relatively flat, several closing parts can be provided in one package and the hinge means can be provided at a different location or be of a different design.

These and many comparable variations are understood to fall within the framework of the invention as outlined by the claims.

1. A mold for manufacturing a package for products, comprising at least one mold cavity for forming the package, wherein in the mold cavity hinge forming means are provided for forming hinge means, while on a first side of the hinge forming means at least a first insert piece is provided for forming suspension means for the package and/or on the opposite side, at least a second insert piece is provided for forming a receiving cavity in the package, the first and/or second insert piece being exchangeable for different first and/or second insert pieces with a configuration deviating from the first and second insert pieces, respectively.

2. A mold according to claim 1, wherein a series of first insert pieces is provided to be placed in the mold, the first insert pieces mutually differing as to the position and/or dimension and/or form of an opening forming part received therein.

3. A mold according to claim 1, wherein a series of second insert pieces is provided to be placed in the mold, the second insert pieces mutually differing as to position and/or form and/or dimension of cavity forming means thereon.

4. A mold according to claim 1, wherein at least one third insert piece is provided opposite the first insert piece, for cooperation therewith, which third insert piece is exchangeable for a different third insert piece.

5. A mold according to claim 1, wherein at least one fourth insert piece is provided opposite the second insert piece, for cooperation therewith, which fourth insert piece is exchangeable for a different fourth insert piece.

6. A mold according to claim 1, wherein on both sides of the hinge forming means, the mold cavity comprises a molded part for forming a closing part of the package, while at least the respective molded parts have a curved form such that, in closed condition, the package formed with the mold has a curved form and can stand independently on a longitudinal edge of the closing parts.

7. A mold according to claim 6, wherein said longitudinal edge is at least substantially formed by the hinge forming means.

8. A mold according to claim 1, wherein at least the first and second insert pieces are placed such that the suspension means and receiving cavity to be formed therewith are on a straight line, which line extends that right angles to a hinge line defined by the hinge forming means.

9. A method for manufacturing a package with the aid of a mold according to claim 1, wherein on the basis of weight and/or form of a product to be packaged at least a first and/or second insert piece is chosen which is placed in the mold, the first insert piece being chosen such that with the package, closed with the product received therein, suspension means formed by the first insert piece are located on a straight line above the centre of gravity of the product, which straight line includes a pre-selected angle with the bottom side of the package.

10. A method according to claim 9, wherein hinge forming means are used forming at least to interspaced lips connected to closing parts on, both sides thereof.

11. A package, comprising a first and a second closing part connected thereto by hinge means, integrally injection molded, wherein at least one of the closing parts comprises a cavity such that if the closing parts are pivoted against each other along the hinge means, a receiving space is enclosed for packaging a product, while the closing parts are slightly curved, at least adjacent the hinge means such that, in closed condition, the package can stand freely on the longitudinal edge located adjacent the hinge means or formed thereby.

12. A package, comprising a first and a second closing part connected thereto via hinge means, integrally injection molded, wherein at least one of the closing parts comprises a cavity such that if the closing parts are pivoted against each other along the hinge means, a receiving space is enclosed for packaging a product, while at least a part of the walls of the receiving cavity are defined by cover parts of a sub-package, which cover parts are connected to the closing parts via break lips or such weakening means such that after opening the package, the sub-package can be broken from the closing parts and is suitable as take-away package for at least one product packaged in the package.

13. A package according to claim 12, wherein the sub-package comprises hinge means, substantially coinciding with or forming part of the hinge means connecting the closing parts.

14. (canceled)

15. A package or series of packages according to claim 11, wherein at least closing means are provided with printing, applied, in particular, through mold labelling technique.

16. A series of packages, comprising a first and a second closing part connected thereto by hinge means, integrally injection molded, wherein at least one of the closing parts comprises a cavity such that if the closing parts are pivoted against each other along the hinge means, a receiving space is enclosed for packaging a product, while the closing parts are slightly curved, at least adjacent the hinge means such that, in closed condition, the package can stand freely on the longitudinal edge located adjacent the hinge means or formed thereby, manufactured with the aid of a mold comprising at least one mold cavity for forming the package, wherein in the mold cavity hinge forming means are provided for forming hinge means, while on a first side of the hinge forming means at least a first insert piece is provided for forming suspension means for the package and/or on the opposite side, at least a second insert piece is provided for forming a receiving cavity in the package, the first and/or second insert piece being exchangeable for different first and/or second insert pieces with a configuration deviating from the first and second insert pieces, respectively, and said series of packages mutually differ in form and/or suspension means and/or receiving means.

17. A series of packages, comprising a first and a second closing part connected thereto via hinge means, integrally injection molded, wherein at least one of the closing parts comprises a cavity such that if the closing parts are pivoted against each other along the hinge means, a receiving space is enclosed for packaging a product, while at least a part of the walls of the receiving cavity are defined by cover parts of a sub-package, which cover parts are connected to the closing parts via break lips or such weakening means such that after opening the package, the sub-package can be broken from the closing parts and is suitable as take-away package for at least one product packaged in the package, manufactured with the aid of a mold comprising at least one mold cavity for forming the package, wherein in the mold cavity hinge forming means are provided for forming hinge means, while on a first side of the hinge forming means at least a first insert piece is provided for forming suspension means for the package and/or on the opposite side, at least a second insert piece is provided for forming a receiving cavity in the package, the first and/or second insert piece being exchangeable for different first and/or second insert pieces with a configuration deviating from the first and second insert pieces, respectively, and said series of packages mutually differ in form and/or suspension means and/or receiving means.

18. A series of packages, comprising a first and a second closing part connected thereto by hinge means, integrally injection molded, wherein at least one of the closing parts comprises a cavity such that if the closing parts are pivoted against each other along the hinge means, a receiving space is enclosed for packaging a product, while the closing parts are slightly curved, at least adjacent the hinge means such that, in closed condition, the package can stand freely on the longitudinal edge located adjacent the hinge means or formed thereby, manufactured with the aid of a mold comprising at least one mold cavity for forming the package, wherein in the mold cavity hinge forming means are provided for forming hinge means, while on a first side of the hinge forming means at least a first insert piece is provided for forming suspension means for the package and/or on the opposite side, at least a second insert piece is provided for forming a receiving cavity in the package, the first and/or second insert piece being exchangeable for different first and/or second insert pieces with a configuration deviating from the first and second insert pieces, respectively, wherein on the basis of weight and/or form of a product to be packaged at least a first and/or second insert piece is chosen which is placed in the mold, the first insert piece being chosen such that with the package, closed with the product received therein, suspension means formed by the first insert piece are located on a straight line above the centre of gravity of the product, which straight line includes a pre-selected angle with the bottom side of the package, and said series of packages mutually differ in form and/or suspension means and/or receiving means.

19. A series of packages, comprising a first and a second closing part connected thereto via hinge means, integrally injection molded, wherein at least one of the closing parts comprises a cavity such that if the closing parts are pivoted against each other along the hinge means, a receiving space is enclosed for packaging a product, while at least a part of the walls of the receiving cavity are defined by cover parts of a sub-package, which cover parts are connected to the closing parts via break lips or such weakening means such that after opening the package, the sub-package can be broken from the closing parts and is suitable as take-away package for at least one product packaged in the package, manufactured with the aid of a mold comprising at least one mold cavity for forming the package, wherein in the mold cavity hinge forming means are provided for forming hinge means, while on a first side of the hinge forming means at least a first insert piece is provided for forming suspension means for the package and/or on the opposite side, at least a second insert piece is provided for forming a receiving cavity in the package, the first and/or second insert piece being exchangeable for different first and/or second insert pieces with a configuration deviating from the first and second insert pieces, respectively, wherein on the basis of weight and/or form of a product to be packaged at least a first and/or second insert piece is chosen which is placed in the mold, the first insert piece being chosen such that with the package, closed with the product received therein, suspension means formed by the first insert piece are located on a straight line above the centre of gravity of the product, which straight line includes a pre-selected angle with the bottom side of the package, and said series of packages mutually differ in form and/or suspension means and/or receiving means.

20. A package or series of packages according to claim 12, wherein at least closing means are provided with printing, applied, in particular through mold labeling technique.

21. A package or series of packages according to claim 13, wherein at least closing means are provided with printing, applied, in particular through mold labeling technique.

22. A package or series of packages according to claim 16, wherein at least closing means are provided with printing, applied, in particular through mold labeling technique.

23. A package or series of packages according to claim 17, wherein at least closing means are provided with printing, applied, in particular through mold labeling technique.

24. A package or series of packages according to claim 18, wherein at least closing means are provided with printing, applied, in particular through mold labeling technique.

25. A package or series of packages according to claim 19, wherein at least closing means are provided with printing, applied, in particular through mold labeling technique.
